(19) United States
(12) Patent Application Publication
(10) Pub. No.: US 2020/0116612 A1
(43) Pub. Date: Apr. 16, 2020

(54) CORIOLIS FLOW METER FOR MEASURING PROPERTIES OF A FLUID AND METHOD THEREFOR

(71) Applicant: GENERAL ELECTRIC COMPANY, SCHENECTADY, NY (US)

(72) Inventors: JENS RUETTEN, MUNICH (DE); PHILIPP LANG, MUNICH (DE); CHARLES ERKLIN SEELEY, NISKAYUNA, NY (US)

(73) Assignee: GENERAL ELECTRIC COMPANY, SCHENECTADY, NY (US)

(21) Appl. No.: 16/471,787

(22) PCT Filed: Dec. 18, 2017
(86) PCT No.: PCT/EP2017/083237

§ 371 Date: Jun. 20, 2019

Related U.S. Application Data
(63) Continuation-in-part of application No. 15/384,771, filed on Dec. 20, 2016, now Pat. No. 10,119,851.
Application No. 15/384,771 is a continuation-in-part of application No. 15/384,806, filed on Dec. 20, 2016, now abandoned.

(51) Int. Cl. G01N 9/32; G01F 1/84; G01N 21/33; G01N 27/04; G01K 11/00

(52) U.S. Cl. CPC G01N 9/32; G01F 1/8422; G01F 1/8431; G01K 11/00; G01F 1/8413; G01N 21/33; G01N 27/04; G01F 1/8472

(57) ABSTRACT

A Coriolis flow meter for measuring one or more properties of a fluid is described herein which involves a modular configuration, and includes a fluid flow sub-system and a mechanical oscillator sub-system, both functionally separate, and are coupled in a closed loop arrangement, such that the flow conduit is not directly vibrated, and instead receives induced oscillations from the mechanical oscillator sub-system. The Coriolis flow meter is useful for high purity applications, as well as for the bioprocessing applications. Bioprocessing systems incorporating the Coriolis flow meter are also described herein. Method for measuring one or more properties of a fluid using the disclosed Coriolis flow meter are also described herein.

### BACKGROUND

This disclosure relates generally to a Coriolis flow meter for measuring one or more properties of a fluid including fluid flow, and more particularly to a Coriolis flow meter where the fluid flow sub-system is functionally separate from the mechanical oscillator sub-system, and even more particularly to a Coriolis flow meter for use in a bioprocessing system.

Coriolis flow meters are used to measure mass flow of fluids flowing through a pipeline in different industrial process engineering environments. Coriolis flow meters have one or more flow tubes, each having a set of natural vibration modes which may be of a simple bending, torsional, or twisting type. Each material filled flow tube is driven to oscillate at resonance in one of these natural vibration modes. The natural vibration modes are defined in part by the combined mass of the flow tubes and the material within the flow tubes. In most Coriolis flow meters, the fluid flows into the Coriolis flow meter from a connected pipeline on the inlet side. The fluid is then directed through the flow tube or flow tubes and delivered to a pipeline connected on the outlet side.

Typically, the flow tube is oscillated using electromagnetic excitation. When there is no flow through the Coriolis flow meter, all points along a flow tube oscillate with an identical phase. As the material begins to flow, Coriolis accelerations cause each point along the flow tube to have a different phase with respect to other points along the flow tube. Motion sensors on the flow tube produce sinusoidal signals representative of the motion of the flow tube. The phase difference between the sensor signals is proportional to the mass flow rate of the material flowing through the flow tube or flow tubes.

Most Coriolis flow meters are made of metal such as aluminum, steel, stainless steel and titanium. It is known to use Coriolis flow meters having different flow tube configurations. Among these configurations are single tube, dual tubes, straight tube, curved tube, and flow tubes of irregular configuration. The flow tubes also function as a mechanical oscillator.

In these prior art Coriolis flow meters, the frequency range of the oscillation modes is therefore dominated by the design and material of the flow tube, and therefore, choice of material, geometry and thickness of the flow tube have to be tailored to composition, pressure and temperature range, or other such properties of the fluid under test.

### BRIEF DESCRIPTION

In one aspect, a Coriolis flow meter for measuring one or more properties of a fluid is disclosed. The fluid flow sub-system is configured to provide a flow path for the fluid, and a mechanical oscillator sub-system is disposed in proximity to the fluid flow sub-system, where the mechanical oscillator sub-system and the fluid flow sub-system are functionally separate.

The mechanical oscillator sub-system is configured to induce oscillations in the fluid flow sub-system, and further configured to detect a Coriolis response from the fluid. The mechanical oscillator sub-system includes a mechanical oscillator, linked with the fluid flow sub-system, and configured to provide a closed-loop arrangement for transmission of oscillations to the fluid and receipt of the Coriolis response from the fluid. The mechanical oscillator sub-system also includes one or more actuators for generating oscillations in the mechanical oscillator, and a sensing sub-system configured to receive the Coriolis response through the mechanical oscillator from the fluid. The Coriolis flow meter may comprise a flow conduit, one or more actuators and one or more sensors. One or more of these may be configured as disposable or single-use parts.

The Coriolis flow meter also includes an electronics circuitry coupled to the mechanical oscillator sub-system, and configured to trigger the one or more actuators and the sensing sub-system, and configured to process the Coriolis response received from the sensing sub-system to generate one or more measurements representative of one or more fluid properties of the fluid.

A disposable-part sub-system may include a flow conduit, one or more actuators, one or more sensors, where either of these or parts of these components, or combinations are configured as disposable parts. An electronics circuitry may be coupled to the disposable-part sub-system, and configured to trigger the one or more actuators and the one or more sensors, and configured to process the Coriolis response received from the one or more sensors to generate one or more measurements representative of the one or more properties of the fluid.

In another aspect, a bioprocessing system for monitoring one or more fluid properties of a fluid used in a bioprocess unit is disclosed. The bioprocessing system includes an inlet tubing and an outlet tubing of the bioprocess unit, where the inlet tubing is connected to an inlet process connect, and the outlet tubing is connected to an outlet process connect. The bioprocessing system includes the Coriolis flow meter described hereinabove, coupled to the inlet process connect and the outlet process connect, and a monitoring unit configured for receiving the measurements representative of the one or more fluid properties of the fluid, and configured to use the measurements to control the bioprocess.

In yet another aspect, a bioprocessing system for monitoring one or more fluid properties of a fluid used in a bioprocess unit is disclosed, where the bioprocess unit includes a fluid flow sub-system for transferring a fluid in a bioprocess of the bioprocess unit. The fluid flow sub-system is shared with the other components of the Coriolis flow meter described herein above. In other words, the fluid flow sub-system is common to the bioprocess unit and the Coriolis flow meter. The bioprocessing system includes a monitoring unit configured for receiving the measurements representative of the one or more fluid properties of the fluid, and configured to use the measurements to control the bioprocess.

In another aspect, a single-use flow kit for a bioprocessing system is disclosed. The flow kit comprises the fluid flow sub-system as discussed above, fluidically connected to tubing, one or more single-use sensor components and one or more manifolds. It is arranged to be mounted in a bioprocessing system as discussed above, where it provides the system with a single-use flow path.

In yet another aspect, a method for measuring one or more fluid properties of a fluid using a Coriolis flow meter is described herein. The method includes the steps for providing a fluid flow sub-system to retain a fluid in a flow conduit; providing a mechanical oscillator sub-system described herein above, and providing an electronics circuitry coupled to the mechanical oscillator sub-system. The method includes a step for transmitting an electrical signal to trigger oscillations in the fluid through the mechanical oscillator sub-system; a step for receiving a Coriolis response from the fluid through the mechanical oscillator sub-system; and a step for processing the Coriolis response to obtain one or more measurements representative of the one or more fluid properties of the fluid.

In yet another aspect, a method for measuring one or more properties of a fluid using a Coriolis flow meter is described herein. The method includes the steps for providing a disposable-part sub-system and providing an electronics circuitry coupled to the disposable-part sub-system, described hereinabove, where one or more components are configured as disposable parts. The method includes a step for transmitting an electrical signal to trigger oscillations in the fluid receiving a Coriolis response from the fluid; and a step for processing the Coriolis response to obtain one or more measurements representative of the one or more fluid properties of the fluid. The Coriolis flow meter may include a disposable-part sub-system described hereinabove where one or more components are configured as disposable parts.

In yet another aspect, a method for monitoring one or more fluid properties of a fluid in a bioprocess of a bioprocessing system is described herein. The method includes coupling an inlet tubing and an outlet tubing of a bioprocess with a Coriolis flow meter described hereinabove using process connects, transmitting an electrical signal to trigger oscillations in the fluid through the mechanical oscillator sub-system; receiving a Coriolis response from the fluid through the mechanical oscillator sub-system; processing the Coriolis response to obtain one or more measurements representative of the one or more fluid properties of the fluid; and monitoring the bioprocess using the one or more measurements. The one or more fluid properties comprise at least one of mass flow rate, density, or temperature of the fluid.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatic representation of an embodiment of a Coriolis flow meter in accordance with some embodiments;

FIG. 2 is a block diagram representation of an embodiment of the Coriolis flow meter in accordance with some embodiments;

FIGS. 3-9 are diagrammatic representations of some example implementations of the Coriolis flow meter in accordance with some embodiments;

FIG. 10 is a block diagram representation of an embodiment of a bioprocessing system that uses the Coriolis flow meter of FIG. 2, in accordance with some;

FIG. 11 illustrates a flowchart showing steps for a method for measuring one or more properties of a fluid including fluid flow using a Coriolis flow meter, in accordance with some embodiments;

FIG. 12 illustrates a flowchart showing steps for a method for measuring one or more properties of a fluid including fluid flow in a bioprocess of a bioprocessing system, in accordance with some embodiments; and

FIG. 13 illustrates a block diagram representation of another embodiment of a bioprocessing system that shares a fluid flow sub-system with the Coriolis flow meter of FIG. 2, in accordance with some embodiments.

FIG. 14 is a block diagram representation of an embodiment of the Coriolis flow meter in accordance with some embodiments;

FIG. 15 is a block diagram representation of one implementation of the embodiment of FIG. 14;

FIGS. 16-19 are diagrammatic representations of some example implementations of the Coriolis flow meter in accordance with some embodiments;

FIG. 20 is a block diagram representation of an embodiment of a bioprocessing system that uses the Coriolis flow meter of FIG. 14.

FIG. 21 shows a single use flow kit according to the invention.

### DETAILED DESCRIPTION

As mentioned hereinabove, a Coriolis flow meter is used for measuring fluid and fluid flow properties in a process in any processing system that uses fluids, such as a bioprocessing system. The different embodiments presented herein describe advantageous features for the Coriolis flow meter that alleviate constraints related to the choice of applicable materials and manufacturing processes required for manufacturing the Coriolis flow meter.

It would be appreciated by those skilled in the art that each process may have its own requirements to which the Coriolis flow meter must adhere to, for ensuring accurate measurements, process integrity as well as longevity of the meter itself. For example, in one process, contamination of the fluid is highly undesirable, since an ultra-high level of purity must be maintained in the fluid returned by the Coriolis flow meter, back to the process. The embodiments presented herein address such requirements. In some other processes bio-sensitivity is important, and in some other processes, the fluid is corrosive, some of the embodiments presented herein also address such requirements. In some other processes, the nature of the process may require the flow conduit to be configurable in different geometries, and yet in some other processes, there may be a need of having the flow conduit disposable to allow only a single time use. Select embodiments presented here also address such requirements.

The embodiments described herein are useful for measurements of fluid properties such as mass flow rates, density, temperature, and the like, and are especially useful for several bioprocessing systems, that involve processes sensitive to contamination with both impurities as well as active biological material, as is common in the production in pharmaceuticals, and in cell biology.

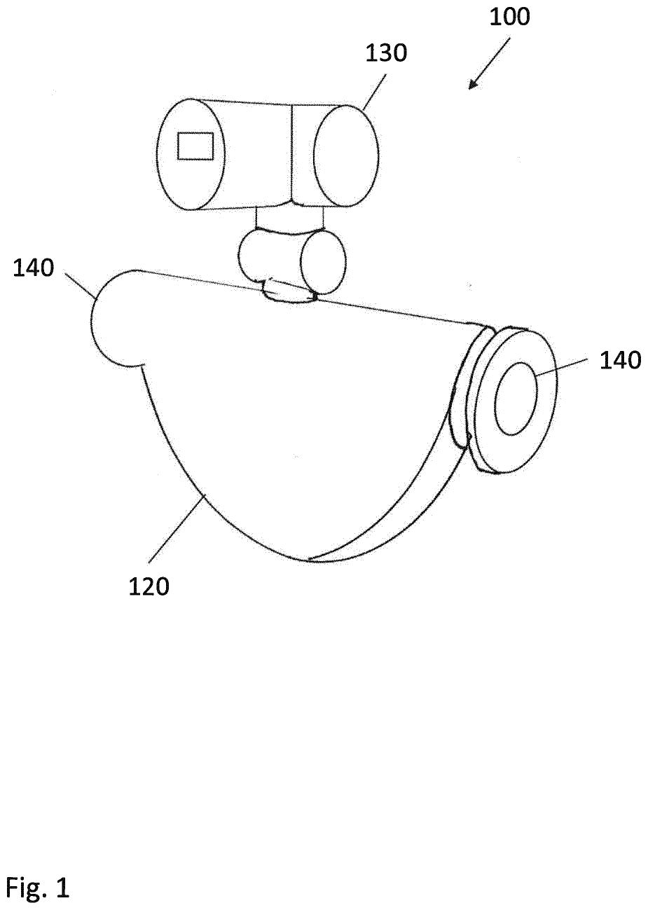

FIG. 1 is a diagrammatic representation of an embodiment of a Coriolis flow meter 100, having an enclosure 120 to house the mechanical oscillator sub-system, and the fluid flow sub-system; an enclosure 130 to house electronics circuitry that is used to operate the mechanical oscillator sub-system, and process connects 140 that connect to an inlet tubing and an outlet tubing (not shown) of a process in which the fluid and fluid flow is being monitoring, such as a bioprocess in a bioprocessing system. It may be appreciated by those skilled in the art that the embodiment of FIG. 1 is a non-limiting example of housing different components of the Coriolis flow meter 100, and based on the end use application the enclosures 120 and 130 and process connects 140 may be configured in a different manner.

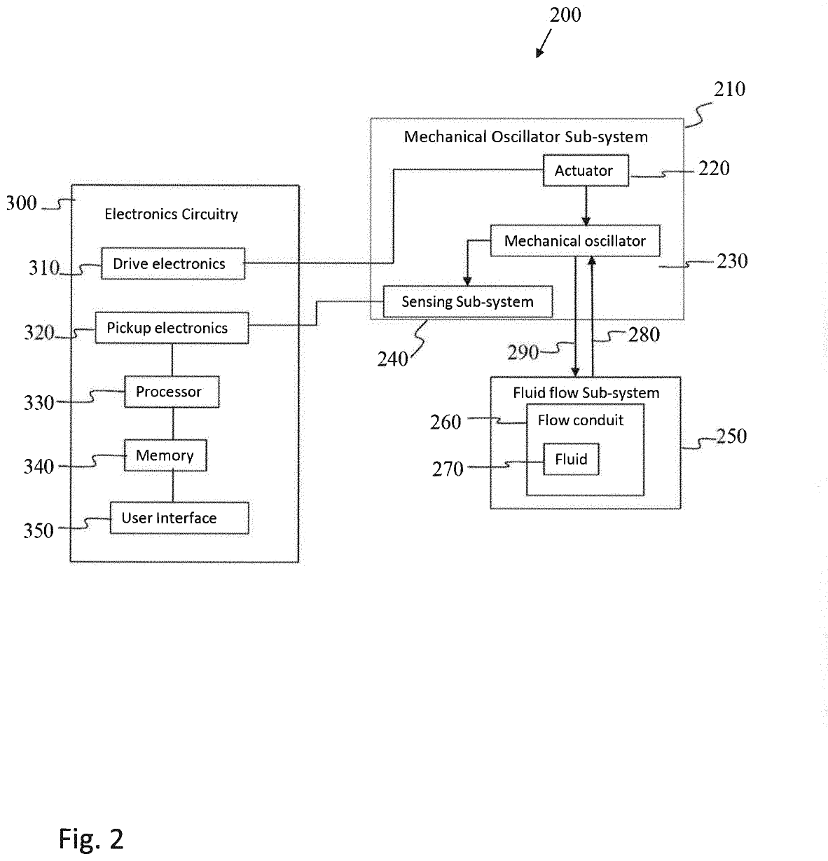

FIG. 2 is a block diagram representation of an embodiment of the Coriolis flow meter 200 that includes a mechanical oscillator sub-system 210. The mechanical oscillator sub-system 210 includes one or more actuators 220, a mechanical oscillator 230 and a sensing sub-system 240. The one or more actuators 220 are used to induce oscillations of an appropriate amplitude over a required frequency range in the mechanical oscillator 230. The one or more actuators 220 may be directly coupled to the mechanical oscillator 230 (e.g. an electromagnetic coil), or may be indirectly coupled using external actuating components (e.g. a mechanical coupling, ferromagnetic parts, and the like). The sensing sub-system 240 includes pick-up sensors, for example, permanent magnet based sensors, or optical sensors, and associated components.

As shown in FIG. 2, the Coriolis flow meter 200 includes a fluid flow sub-system 250 that is functionally separate from the mechanical oscillator sub-system 210, and removes the constraints of the prior art where the fluid flow system itself is used as a mechanical oscillator, and both are functionally integral. Functionally separate herein implies that the fluid flow sub-system is a distinct component in itself, distinct from the mechanical oscillator sub-system.

The fluid flow sub-system 250 is configured to provide a flow path for the fluid 270 that is retained in a flow conduit 260. The flow conduit 260 is configured in a shape of commonly employed principles for Coriolis measurement, including but not limited to single, dual or multi loop configurations, split flow, straight tube, counter- or co-flow configurations. In some implementations, the flow conduit is made from, for example, polymer, whose influence on the oscillation modes (harmonic frequencies) of the mechanical oscillator is not dominant. The flow conduit material in some examples, is tailored to specific requirements of the bioprocessing application, such as temperature, pressure, and the characteristics of the fluid to be measured (e.g. mass flow rate, density, corrosivity etc). The material can suitably be a polymeric material complying with the requirements of USP VI (US Pharmacopeia), in particular with respect to levels of leachables and extractables. Furthermore, in some examples, the material of the flow conduit has a significantly lower stiffness than the material employed for the mechanical oscillator 230.

The mechanical oscillator sub-system 210 is disposed in proximity to the fluid flow sub-system 250, and the mechanical oscillator sub-system 210 is configured to induce oscillations in the fluid flow sub-system 250, and is further configured to detect a Coriolis response from the fluid 270. More specifically, the mechanical oscillator 230 is linked with the fluid flow sub-system 250 and is configured to provide a closed-loop arrangement for transmission of oscillations to the fluid 270 and receipt of the Coriolis response from the fluid 270.

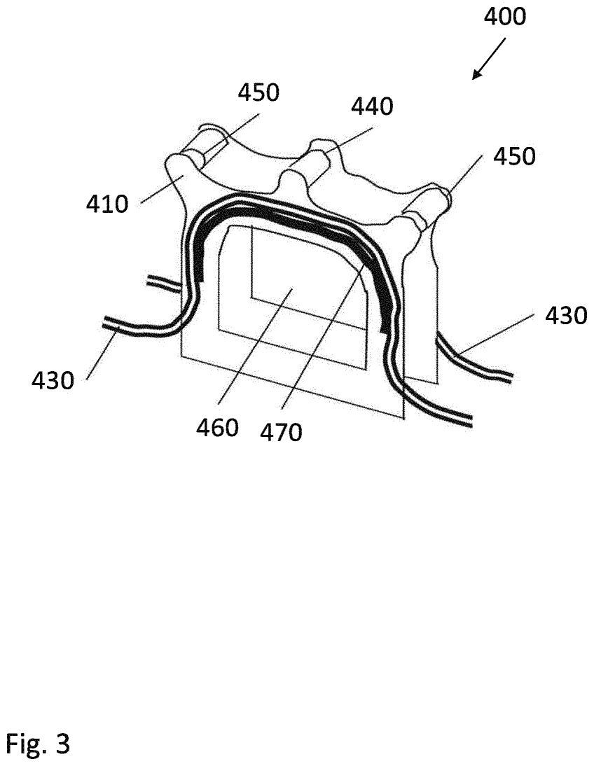

In some implementations, the fluid flow sub-system 250 is directly coupled to the mechanical oscillator 230 body, such that the oscillations of the mechanical oscillator are applied to the flow conduit 260 and the fluid therein. Some examples of such implementations are shown in FIGS. 3-8.

The Coriolis flow meter 200 also includes an electronics circuitry 300 coupled to the mechanical oscillator sub-system 210 or the disposable part sub-system. The electronics circuitry 300 includes drive electronics 310 to trigger the one or more actuator(s) 220 to generate oscillations in the mechanical oscillator 230 of the desired frequency and magnitude. The Coriolis flow meter 200 further includes pick-up electronics 320 to receive the Coriolis response from the sensing sub-system 240. The electronics circuitry 300 further includes a processor 330 to process the Coriolis response received from the sensing sub-system 240 to generate one or more measurements representative of one or more properties of the fluid including fluid flow. These measurements are displayed using a user interface 350. The electronics circuitry 300 also includes a memory 340 to store the measurements for further use and communication, to store data useful for the drive electronics 310, and the pick-up electronics 320.

Under operation, the electronics circuitry 300 triggers the one or more actuator(s) to generate oscillations in the mechanical oscillator 230, which are transferred to the fluid 270 in the flow conduit 260, as shown by arrow 290 in FIG. 2. Due to these oscillations, the Coriolis response (vibration amplitude and phase) is generated in the fluid and travels back to the mechanical oscillator 230, as shown by arrow 280, and is sensed by the sensing sub-system 240. The sensed Coriolis response is transmitted to the electronics circuitry 300 for further processing to obtain the measurements of the one or more properties of the fluid including fluid flow.

The configuration presented in FIG. 2 allows for functional separation of the mechanical oscillation sub-system from the fluid flow sub-system in the Coriolis flow meter. The functional separation extenuates the influence of material properties of the fluid flow sub-system on harmonic frequencies of oscillations that are used to generate the Coriolis response, which in turn is used for measurements of different properties of the fluid and fluid flow.

Separating the functions of the mechanical oscillation sub-system from the fluid flow sub-system, also allows for separate optimization of the materials for the mechanical flow sub-system and for the fluid flow sub-system, to achieve better product cost and unlocks potential for new applications which could not be addressed previously due to limitations of material choice.

The Coriolis flow meter described hereinabove and in the embodiments described herein after, has an advantage of having a modular construction, where the mechanical oscillator sub-system, and the fluid flow sub-system are functionally separate, as well as are modular and allow modular integration. The modular feature described herein provides advantages both from manufacturing aspects, and servicing aspects, and the functional separation provides technical advantages that ensures isolation of the fluid containment part that is encompassed in the fluid flow sub-system, from the mechanical oscillation sub-system.

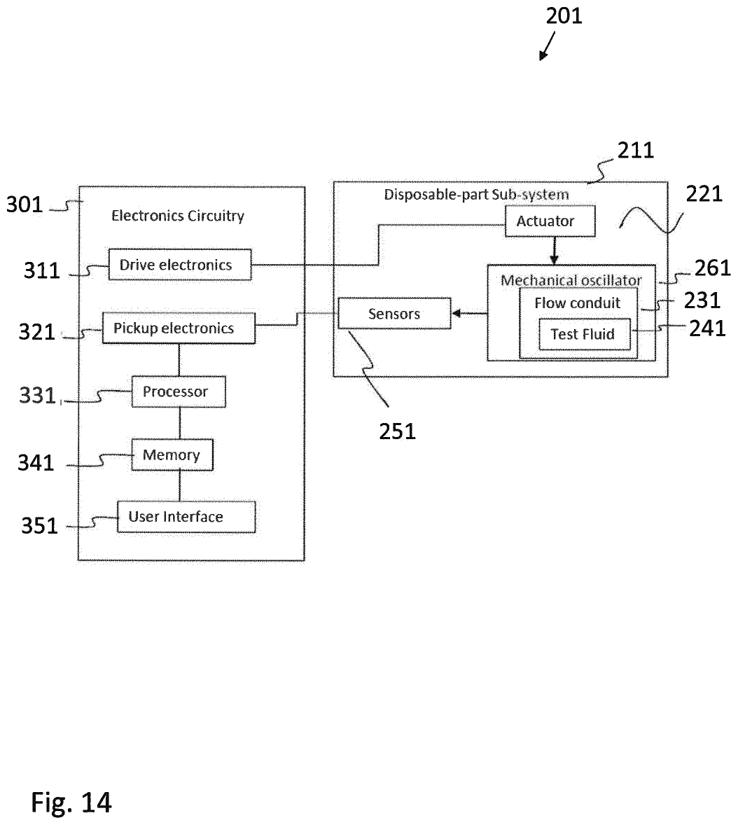

FIG. 14 is a block diagram representation of an embodiment of the Coriolis flow meter 201 that includes a disposable-part sub-system 211. The disposable-part sub-system 211 includes one or more actuators 221, a flow conduit 231 for retaining a fluid 241, and may include one or more sensors 251. It would be appreciated by those skilled in the art, that one or more components of the disposable-part sub-system are configured as disposable parts, and the others are configured as re-usable resident parts.

The disposable-part sub-system 211 has an advantage that at least one of the flow conduit, the one or more actuators, or the one or more sensors is configured as a disposable part, and other parts are configured as reusable resident parts. It would be appreciated by those skilled in the art that the disposable part(s) may be replaced at very low cost in intervals governed by the specific process needs. In addition, in some implementations, the material of the flow conduit 231 may be changed (glass or polymer or silicone or metal), without the need for replacement of the entire Coriolis flow meter. The disposable-part sub-system allows obtaining high accuracy measurements, reusing of part of the Coriolis flow meter 201, provides a flexibility for single-use applications, and achieves cost and material savings.

Referring to FIG. 14, in some implementations, the flow conduit 231 may be coupled with a mechanical oscillator 261 or form a unitary unit with mechanical oscillator 261 and thus take the form of a rigid, oscillating tubing. The one or more actuators 221 are used to induce oscillations of an appropriate amplitude over a required frequency range in the fluid 241 through the mechanical oscillator 261 and the flow conduit 231. The one or more sensors 251 are configured for receiving a Coriolis response from the fluid through the flow conduit. The one or more sensors include, for example, electromagnetic sensors, or optical sensors, and associated components.

The Coriolis flow meter 201 also includes an electronics circuitry 301 coupled to the or the disposable part sub-system. The electronics circuitry 301 includes drive electronics 311 to trigger the one or more actuator(s) 221 to generate oscillations in the mechanical oscillator 231 of the desired frequency and magnitude. The Coriolis flow meter 201 further includes pick-up electronics 321 to receive the Coriolis response from the sensing sub-system 241. The electronics circuitry 301 further includes a processor 331 to process the Coriolis response received from the sensing sub-system 241 to generate one or more measurements representative of one or more properties of the fluid including fluid flow. These measurements are displayed using a user interface 351. The electronics circuitry 301 also includes a memory 341 to store the measurements for further use and communication, to store data useful for the drive electronics 311, and the pick-up electronics 321.

The different embodiments of the Coriolis flow meter as described herein and its different components are described in more detail in reference to FIG. 3-FIG. 9.

FIG. 3 is a diagrammatic representation of some components of a Coriolis flow meter 400. As shown, a mechanical oscillator 410 in this implementation is configured as a twin frame having an open profile 460, and providing a twin U-shape framework for the fluid flow sub-system 470 that includes a pair of flow conduits 430. An electromagnetic coil assembly 440 (electromagnet coil and permanent magnet) is used as the actuator, and pair of similar components 450 are used as sensors of the sensing sub-system 240 that are positioned to directly contact the mechanical oscillator 410.

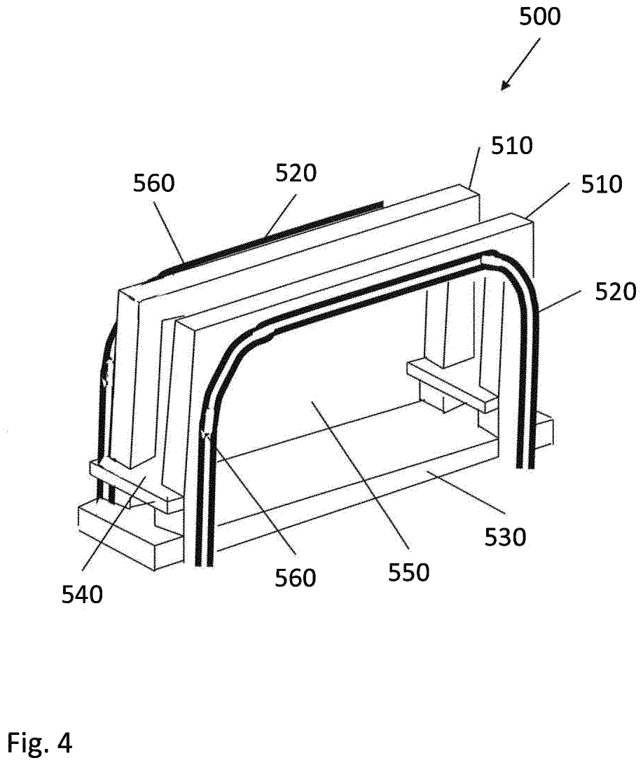

FIG. 4 is another diagrammatic representation of some components of a Coriolis flow meter 500. As shown, a mechanical oscillator 510 in this implementation is configured as paired rectangular frame having an open profile 550. The paired rectangular frame in one example is made from polycarbonate. A paired configuration of the fluid flow sub-system 520 is provided with respective flow conduits 560. The flow conduits in one example are made of silicone. A platform 530 is used to mount the mechanical oscillator 510 and the fluid flow sub-system 520. Brackets 540 are used to hold the mechanical oscillator 510. Other components of actuators and sensors may be provided in the same configuration as shown in FIG. 3, or mounted on the platform 530. In this example, the flow conduit is single use and disposable.

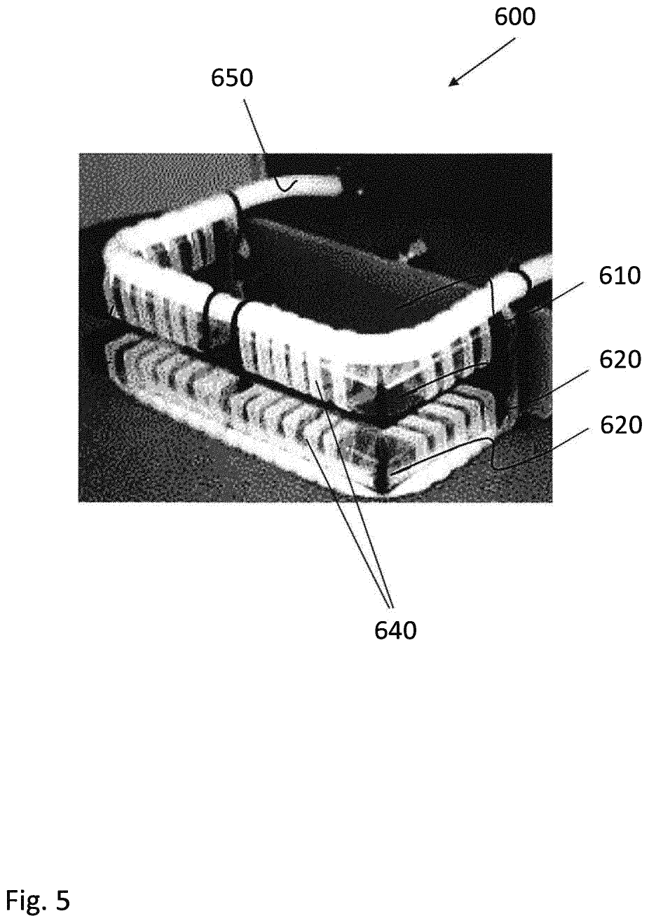

FIG. 5 is an experimental implementation of the configuration of FIG. 4 for implementing some components of a Coriolis flow meter 600. As shown, a mechanical oscillator 620 in this implementation is configured as paired rectangular frame having an open profile 610. A paired configuration of the flow conduits 650, is provided as a fluid flow sub-system, and a wire bundle wrap is 640 is used to attach the flow conduit 650 to the mechanical oscillator 620. In this example, the flow conduit is single use and disposable.

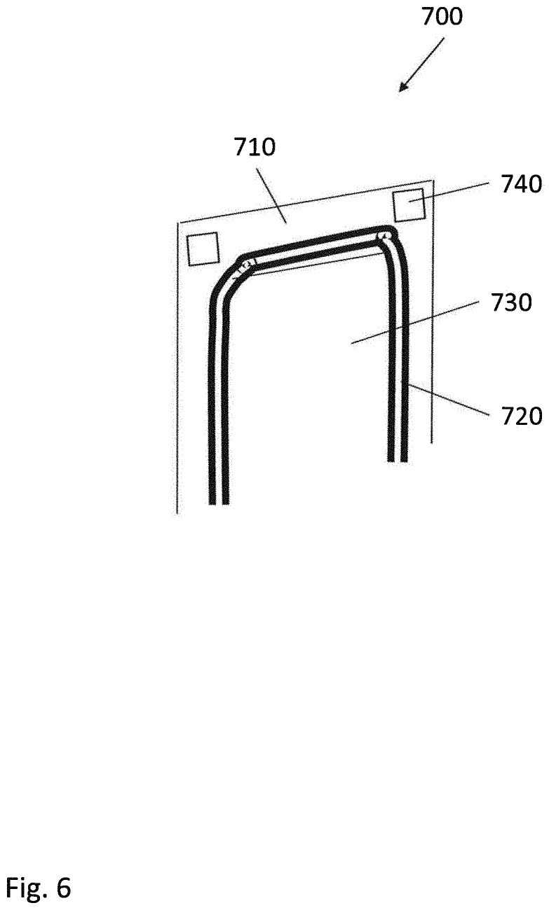

FIG. 6 is yet another configuration for implementing some components of a Coriolis flow meter 700. As shown, a mechanical oscillator 710 is configured as a singular frame having an open profile 730. A paired configuration of the flow conduits 720, is provided as a fluid flow sub-system. In this example, the mechanical oscillator 710 is made of sheet metal substrate, the flow conduit is made from hard plastic, and the pickup sensing has been realized by a non-contact optical method, the laser sensor targeting the reflective patches 740 is not shown in the photograph.

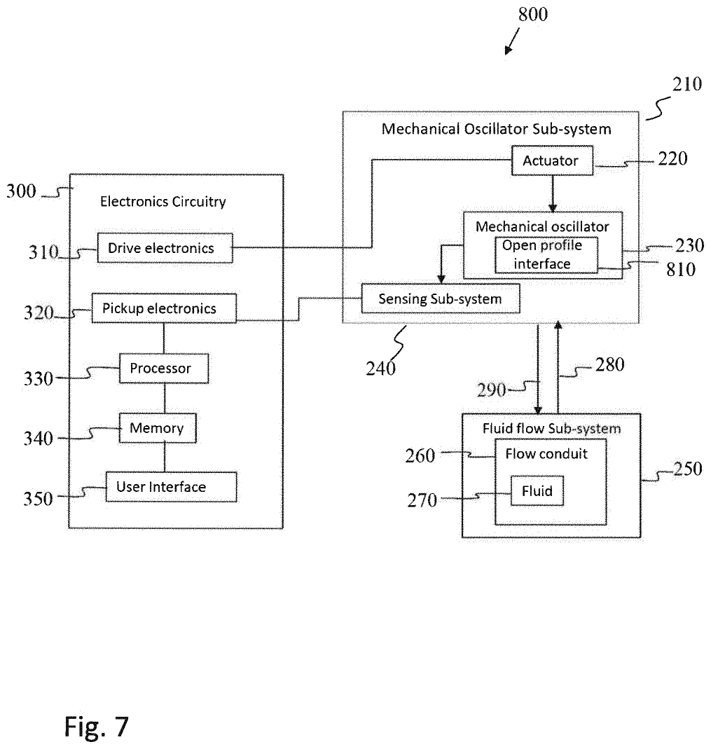

FIG. 7 is a diagrammatic representation of a Coriolis flow meter 800, which is similar to the Coriolis flow meter 200 of FIG. 2, with the additional feature of the open profile interface 810, that in some implementations, can be a separate part or component of the mechanical oscillator 230. The open profile interface advantageously links the fluid flow sub-system in a closed-loop arrangement to the mechanical oscillator sub-system described hereinabove.

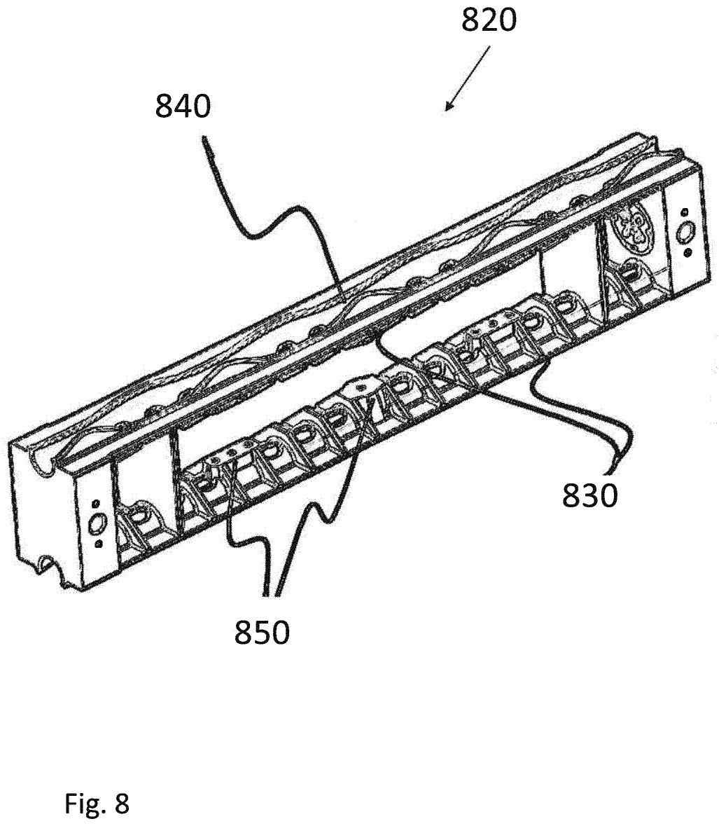

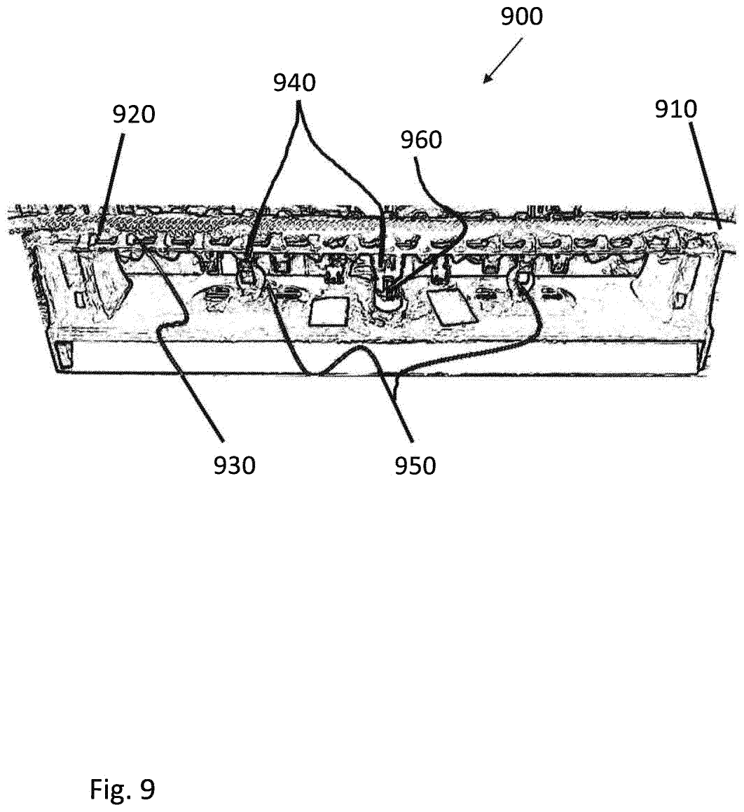

All other components of the Coriolis flow meter 800 of FIG. 7 are same as explained in reference with the FIG. 2 embodiment. FIG. 8 and FIG. 9 are two example representations of the open profile interface 810 that is mountable on the mechanical oscillator and holds the flow conduit described in previous embodiments. In some implementations, the open profile interface and the mechanical oscillator are a unitary unit, and in some they are discrete and are fitted onto each other.

FIG. 8 is a diagrammatic representation for implementing some components of a Coriolis flow meter 820 which includes the mechanical oscillator 830 providing a dual parallel linear framework which in this embodiment are a unitary unit with the open profile interface 840 configured to hold two flow conduits (not shown), and the mounting features for the sensors and actuators 850. It shall be noted that this particular design is fully symmetrical with regard to the horizontal plane.

FIG. 9 is yet another configuration for implementing some components of a Coriolis flow meter 900. In this configuration, the flow conduit 910 is inserted into the open profile interface 920 forming a singular linear framework. The oscillator 930 is defined by steel inserts on either side of the flow conduit and fully integrated into the open profile interface, which furthermore includes mounting features 940 to couple the sensors 950 and the actuator 960 at well-defined positions.

As would be appreciated by those skilled in the art, the open profile interface of FIG. 7-FIG. 9 is disposed in close physical contact with the flow conduit of the Coriolis flow meter, but is not in direct contact with the fluid, that is subject to measurement for mass flow rate.

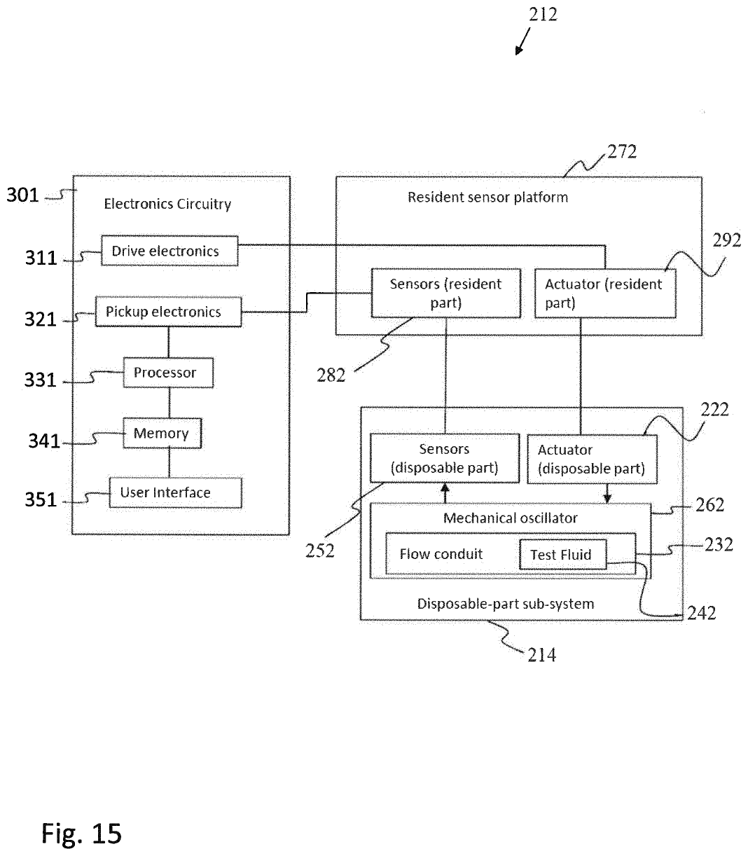

FIG. 15 illustrates embodiments having a disposable-part sub system 214 that includes disposable parts of one or more actuators, shown by block 222, a flow conduit 232 for retaining a fluid 242, and coupled to or with a mechanical oscillator 262. In one example, the disposable-part sub-system 214 also includes disposable parts of one or more sensors, shown by block 252.

In addition, the Coriolis flow meter 212 also includes a resident sensor platform 272 that includes reusable and resident parts of sensors, shown by block 282, and reusable and resident parts of actuators, shown by block 292. The one or more actuators (222 and 292) are used to induce oscillations of an appropriate amplitude over a required frequency range in the fluid 242 through the mechanical oscillator 262 and the flow conduit 232. The resident parts of actuators, shown by block 222, may in one example take the form of an electromagnetic coil, coupling the excitation force required to induce the oscillation by means of a magnetic field to the disposable parts of the actuators shown by block 222 which is situated in direct contact with the mechanical oscillator 262.

The one or more sensors (disposable part, 252 and resident part, 282) are configured for receiving a Coriolis response from the fluid through the flow conduit. The one or more sensors include, for example, electromagnetic sensors, or optical sensors, and associated components. The disposable parts of the sensors shown by block 252 are preferably, but not necessarily, passive elements, such as permanent magnets for electromagnetic sensing methods, or reflective elements for optical sensing methods.

The embodiments described herein above may include additional attachments, clamps and fixtures, such as but not limited to screws, bolts and nuts, adhesives, or may have snap-in grooves and the like to position the mechanical oscillator sub-system, the fluid flow sub-system, and the electronics circuitry.

It would be appreciated by those skilled in the art that the embodiments of FIG. 3-FIG. 9 are provided by way of examples, and other pre-defined shapes for the mechanical oscillator and flow conduit may be configured based on use environment.

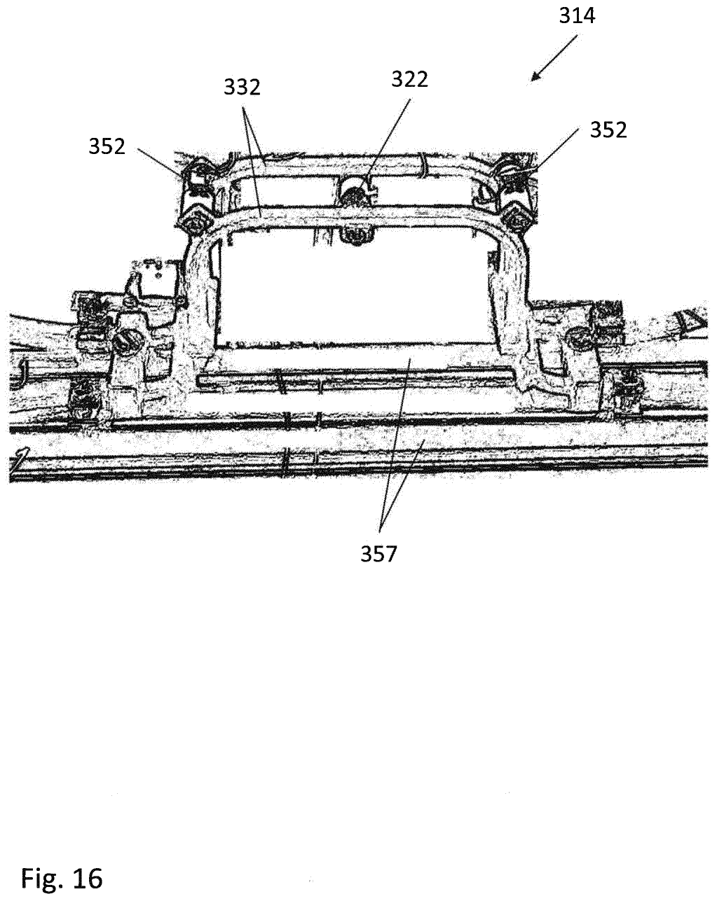

FIG. 16 is a photographic representation of an implementation of the disposable-part sub-system 314. As shown, the disposable-part sub-system 314 includes a U-shaped flow conduit 332 in a twin flow path configuration, the flow conduit 332 is reusable in some implementations, and in some other implementation it is a disposable part. The flow conduit is made of polymer in one example, and made of silicone in yet another example, and of glass in still yet another example.

The other disposable parts in the configuration shown in FIG. 3 include the actuator 322, which is an electromagnetic coil, in one example. Still other disposable parts include the sensors 352 which are permanent magnets in one example. A frame 357 is used to mount the flow conduit 332 onto which the actuator 322 and sensors 352 are mounted by using screws or other attachment means.

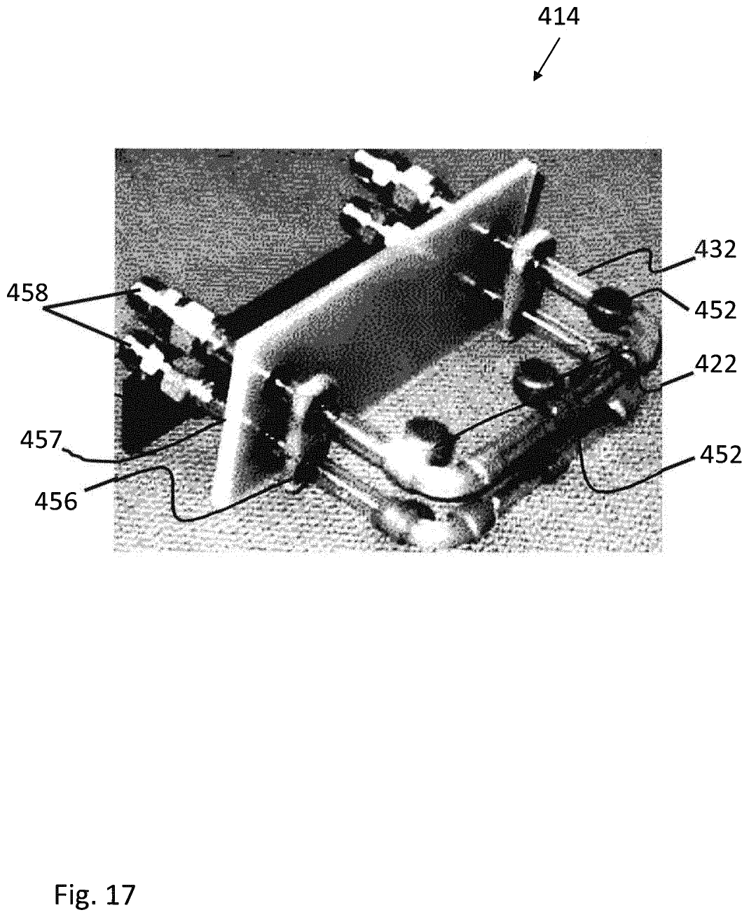

FIG. 17 is another photographic representation of some components of the disposable-part sub-system 414. As shown, disposable-part sub-system 414 in this implementation includes a U-shaped paired configuration of the flow conduit 432, and is reusable, and acts as the mechanical oscillator. In this configuration, also the disposable parts include the actuator 422, which is an electromagnetic coil, in one example. Other disposable parts include the sensors 452 which are permanent magnets in one example. Brackets 456 are used to hold the flow conduit 432 that passes through a frame 457, to connect with process connects 458.

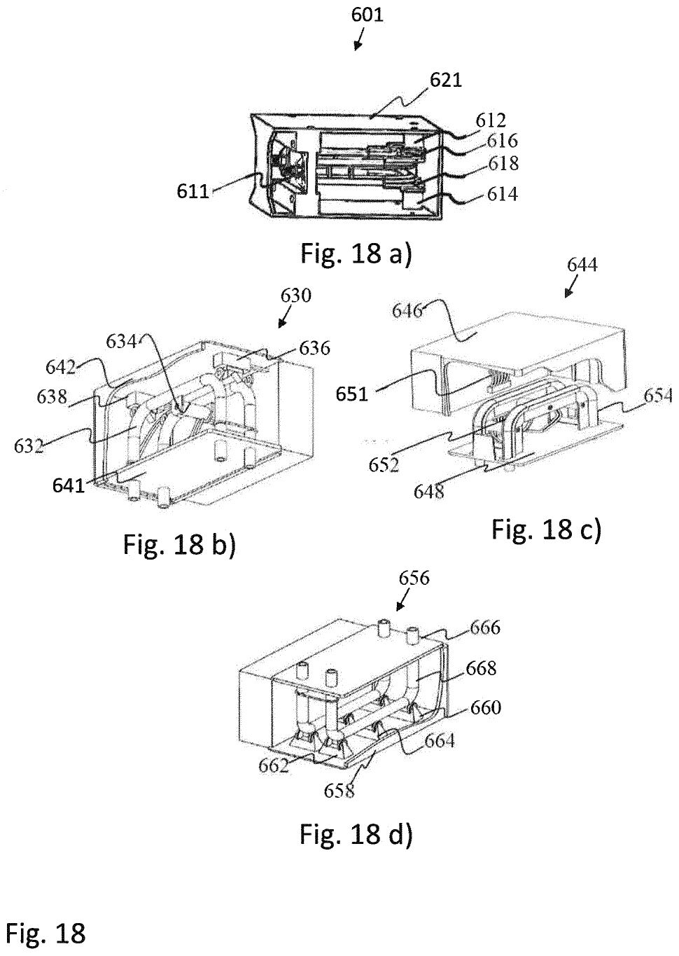

FIG. 18 is a diagrammatic representation of few configurations for implementing some components of the disposable-part sub-system 214. FIG. 18 (a) illustrates a configuration 601, that includes a frame 621 that is configured as a cartridge and is reusable. The flow conduit 611 is the disposable part, and the actuators 616 and 618, as well as the sensors, 612 and 614 are integrated into frame 621 and are the reusable parts.

FIG. 18(b) illustrates another configuration 631 that includes the flow conduit 632 along with the actuator 634, as the disposable parts. The sensors 636 and 638 are optical sensors and are mounted on the frame 642 and are reusable. A base 641 forms a removable but reusable part of the frame 642, for holding the flow conduit 632.

FIG. 18(c) illustrates another configuration 644 that includes the flow conduit 654 that is a disposable part, whereas the actuators and sensors (not marked for clarity) are provided on a base 648 as fixed reusable parts. The base 646 receives and holds the flow conduit 654. A housing 646 is provided to receive the parts mounted on the base 648. The housing includes connectors 651 and 652, which in one example are mechanical connectors for allowing a snap-in configuration for fitting the base 648 into the housing 646. In some other implementation, connectors 651 and 652 electrical connectors configured in a mother-daughter pair, where the connector 652 is a daughter electrical connector of the mother-daughter pair, and the connector 651 is a mother electrical connector of the mother-daughter pair.

FIG. 18(d) illustrates another configuration 656 where the flow conduit 668 is mounted on the frame 666 and is the reusable part. The actuator 664 and the sensors 658 and 660 are magnets are the disposable parts, and are mounted on a reusable frame 658.

It would be appreciated by those skilled in the art that the configurations described hereinabove, are only some non-limiting examples, and other flow path geometries for Coriolis measurement (e.g. single, dual or multi loop configurations, split flow, straight tube, counter- or co-flow) may be implemented in a similar manner.

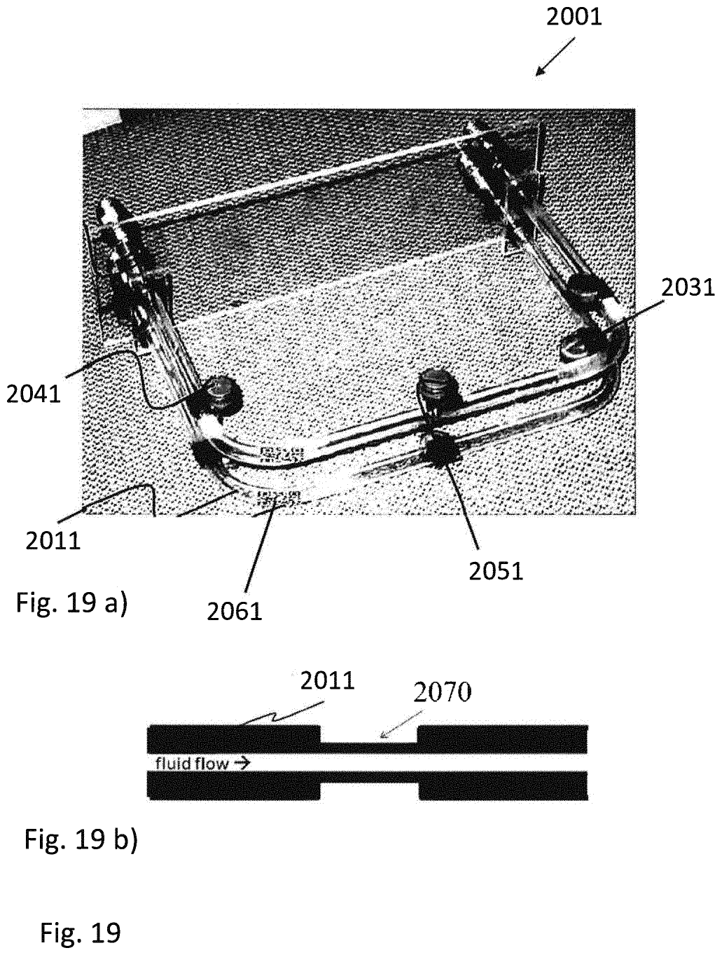

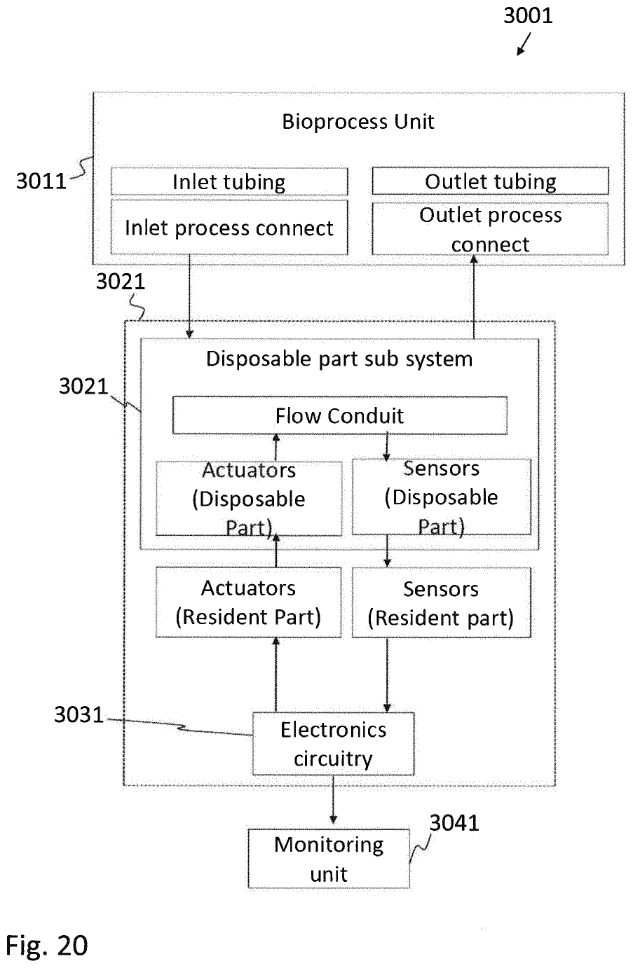

FIG. 19 (a) is a photographic representation of another implementation showing some components of the disposable-part mechanical oscillator 2001. A flow conduit 2011 made of glass is used in this implementation and is mounted on a frame 2051. The magnets 2031, 2041, and 2051 that serve as actuators and sensors are clamped on the flow conduit 2011. In some configurations, the flow conduit 2011 is disposable.

Use of glass for the flow conduit (referred herein as glass flow conduit) in the above embodiments has several advantages due to thermal conductivity, electrical non-conductivity, relative corrosion safety, transparency, of glass flow conduit, that enables additional optical or spectral measurements.

For example, usually for monitoring the process, temperature compensation is usually critical, and in prior art Coriolis flow meters, a separate temperature sensor is included to compensate for the fluid's temperature change induced by the flow conduit material properties such as stiffness. Use of glass flow conduit removes the necessity of the traditional temperature sensor, as the glass flow conduit allows direct optical observation and optical temperature measurements of the fluid. Also, the glass flow conduit enables measurements such as nuclear magnetic resonance based fluid characterization measurements along with the traditional mass flow measurements by the same Coriolis flow meter.

As a further advantage, transparency of the glass flow conduit to visible light spectrum, allows for inspection for any cracks in the flow conduit, by principle of optical scattering produced by interaction of irradiating light with small cracks.

The glass flow conduit, as a disposable part, meets the one-time use requirement, for some applications, for example in medical tests where bodily fluid is required to be analyzed for determining a health-related parameter. In some of these applications, it is often desirable to do an analysis of the fluid as its mass flow rate is being measured. Likewise, it can be advantageously used in bioprocess applications to measure different properties of a bioprocess fluid in conjunction with the mass flow rate. In one embodiment, an insight portal, shown by reference numeral 2070 in FIG. 19(b), may be provided on an outer surface of the glass flow conduit 2011 to enable such analyses. The insight portal includes one or more small regions provided as a groove in the glass flow conduit 2011, in one non-limiting example, departing from the conventional constant outer curvature for the flow conduit, and may be in the form of a flattened groove as shown in FIG. 19 (b). The inner diameter of the flow conduit is not altered, and therefore, the insight portal 2070 causes no narrowing of the flow conduit.

In some implementations, a light source (not shown) may be used to emit radiation through the insight portal 2070 that impinges on the fluid inside the flow conduit 2011, and the reflected radiation is received through a detector (not shown), and processed for measuring select properties for the analysis of fluid, such as opacity, presence or absence of certain elements or compounds, and color of the fluid, and other such properties. It would be understood by those skilled in the art that the radiation may include laser generated light, non-coherent light, spectrally shaped light, microwave radiation, or gamma radiation.

In yet another embodiment, the insight portal 2070 may be used to position a coil (not shown) for generating a magnetic field using a current driver (not shown). Because the glass flow conduit is non-conductive and has negligible permeability, the current driver may produce a steady or time-varying magnetic field within the fluid. Such a magnetic field may be used in conjunction with other sensors disposed external to the glass flow conduit including fluid characterization and analysis of the fluid, complementary and simultaneously with mass flow estimation.

In some other embodiments, useful for inventory management, the glass flow conduit may include a tag (shown as 2061 in FIG. 19(a)), such an RFID (Radio Frequency Identification) tag that is readable using an electronic reader. The tag in one example may include indicium that is printed, etched, or otherwise emplaced on the glass flow conduit 2011. The readout from the tag may be processed by an external processor to localize a placement and orientation of the glass flow conduit, or for moving the glass flow tube using means such as robotic arm to a desired location.

In still another embodiment, the tag 2061 is initially invisible indicium, that only becomes visible after the glass flow tube 2011 is sterilized by exposure to an ultraviolet light source. The advantage of this embodiment, as would be appreciated by those skilled in the art, is the added confirmation of a positive indication of a completion of a sterilization protocol, which may be a requirement for certain applications.

The flow conduit made of glass provides several other advantages, that allow greater ease and accuracy in measurements, such as a lagging thermodynamic interaction between the flow conduit made of glass and the fluid, an expected chemical isolation between the flow conduit made of glass and the fluid, and a reasonable production cost especially, in light of the one-time usage, where the flow tube made of glass is the disposable part.

It would be appreciated by those skilled in the art that the embodiments of FIG. 16-FIG. 19 are provided by way of examples, and other pre-defined shapes for the flow conduit may be configured based on use environment.

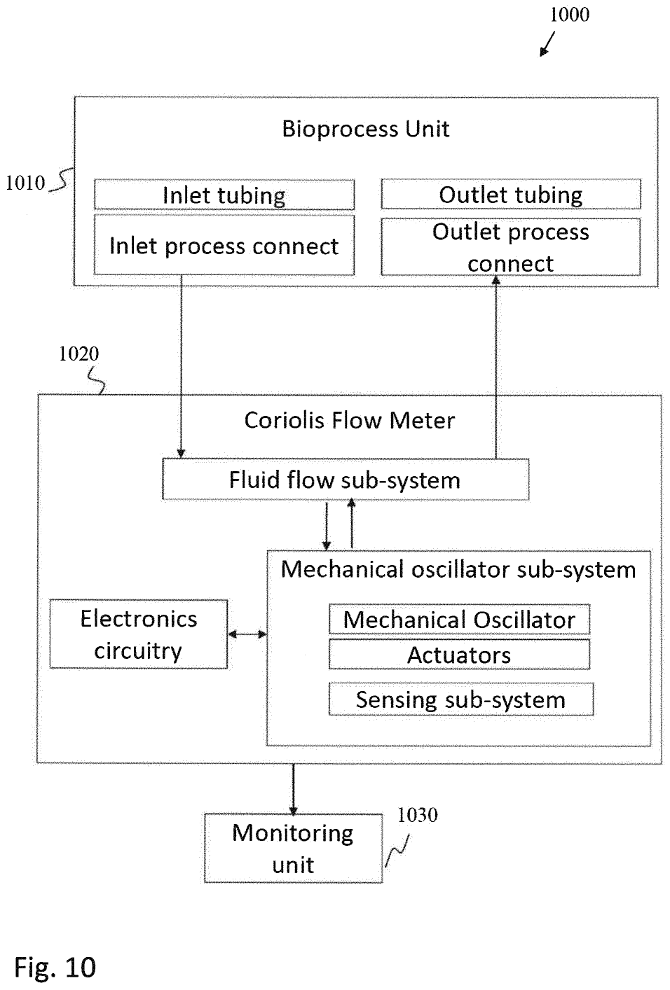

In another aspect, FIG. 10 provides a diagrammatic representation for a bioprocessing system 1000 for monitoring one or more properties of a fluid including fluid flow used in a bioprocess of a bioprocess unit 1010. The bioprocess unit 1010, as shown, includes the inlet tubing with an inlet process connect, and an outlet tubing with an outlet process connect. The other aspects of the bioprocess unit 1010 which involve the actual process are not shown here to limit the discussion to the aspects related to monitoring of the one or more properties of the fluid including fluid flow. The bioprocessing system may e.g. comprise a chromatography system, a filtration system and/or a bioreactor.

As shown in FIG. 10, a Coriolis flow meter 1020 is coupled to the inlet process connect and the outlet process connect of the bioprocess unit 1010. The Coriolis flow meter 1020 referred herein has been described hereinabove in reference with FIGS. 2-9, and includes same components with the same functions. The bioprocessing system 1000, further includes a monitoring unit 1030 that is configured for receiving the measurements representative of the one or more fluid properties of the fluid, from the Coriolis flow meter 1020 and configured to use the measurements to control the bioprocess in the bioprocess unit 1010. All aspects of the Coriolis flow meter of FIGS. 2-9 are applicable in the embodiment of the bioprocessing system 1000.

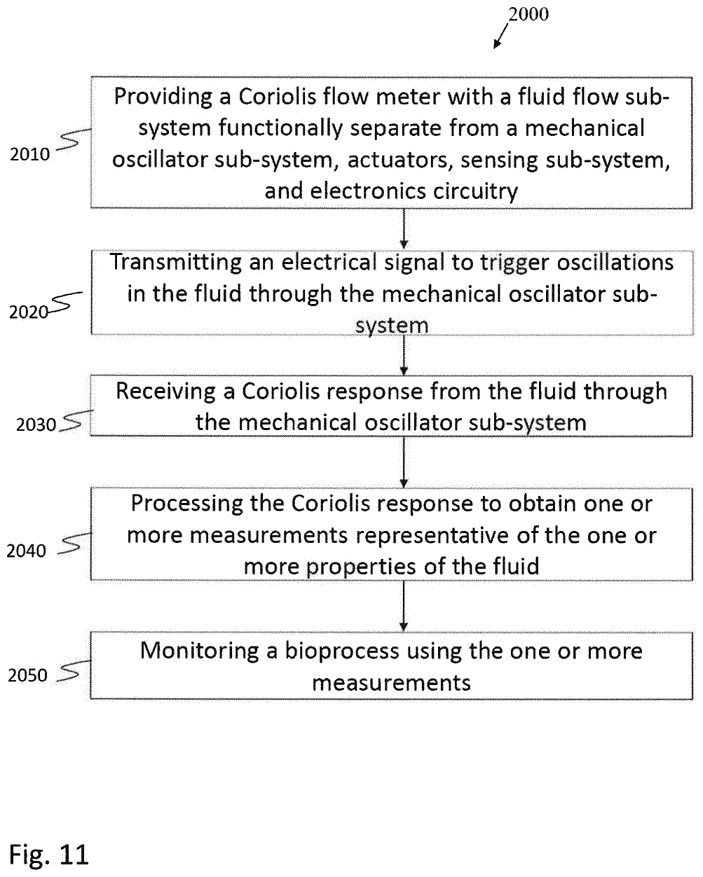

In yet another aspect, FIG. 11 illustrates a flowchart 2000 showing steps for a method for measuring one or more properties of a fluid including fluid flow using a Coriolis flow meter. The Coriolis flow meter referred herein has been described previously in reference to FIGS. 2-9. The method includes a step 2010 for providing the Coriolis flow meter with a fluid flow sub-system functionally separate from a mechanical oscillator sub-system, actuators, sensing sub-system and electronics circuitry. The method includes a step 2020 for transmitting an electrical signal to trigger oscillations in the fluid through the mechanical oscillator sub-system. The method includes a step 2030 for receiving a Coriolis response from the fluid through the mechanical oscillator sub-system; a step 2040 for processing the Coriolis response to obtain one or more measurements representative of the one or more properties of the fluid including fluid flow, and a step 2050 for monitoring a bioprocess using the one or more measurements.

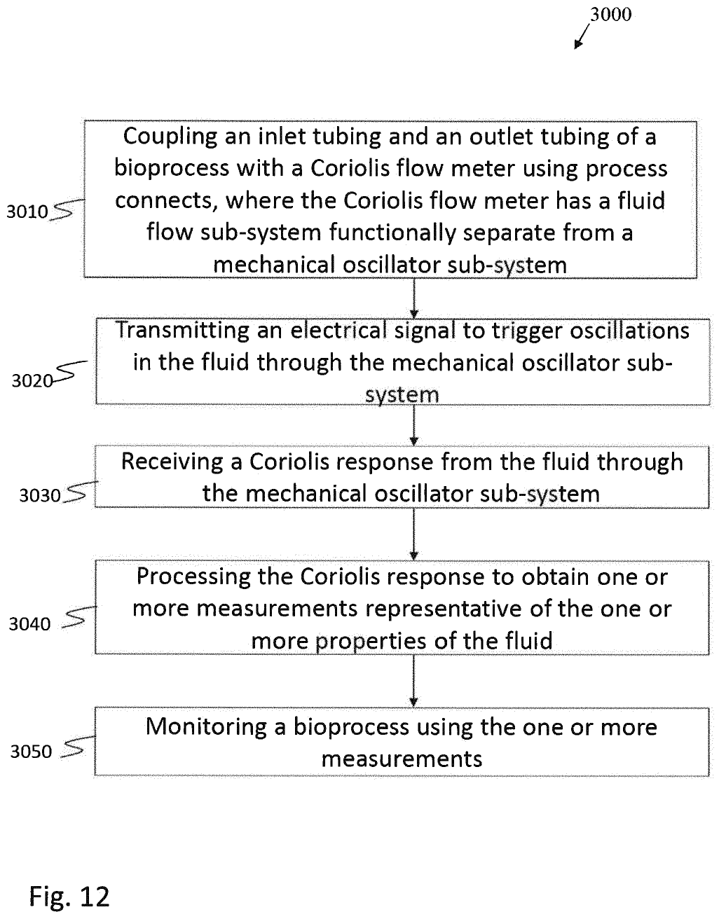

In yet another aspect, FIG. 12 illustrates a flowchart 3000 showing steps for a method for monitoring one or more properties of a fluid including fluid flow in a bioprocess of a bioprocessing system. The method includes a step 3010 for coupling an inlet tubing and an outlet tubing of a bioprocess with a Coriolis flow meter using process connects. The Coriolis flow meter referred herein has been described previously in reference to FIGS. 2-9. The method includes a step 3020 for transmitting an electrical signal to trigger oscillations in the fluid through the mechanical oscillator sub-system. The method includes a step 3030 for receiving a Coriolis response from the fluid through the mechanical oscillator sub-system. The method further includes a step 3040 for processing the Coriolis response to obtain one or more measurements representative of the one or more properties of the fluid including fluid flow, and a step 3050 for monitoring the bioprocess using the one or more measurements.

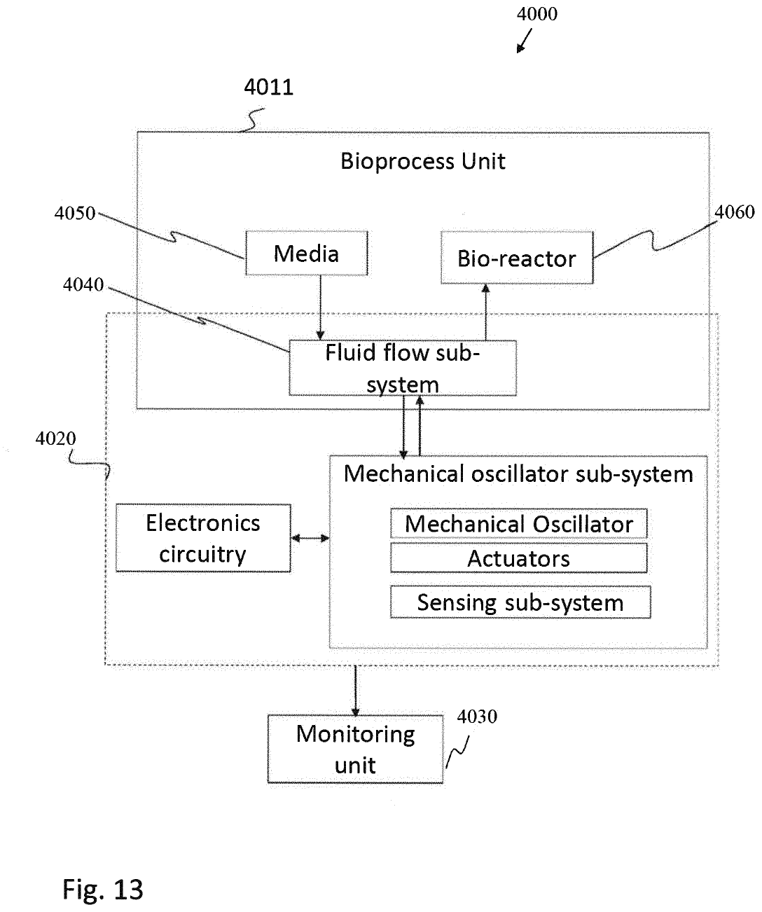

In yet another aspect, the beforementioned functional separation furthermore allows for the fluid containment of the superordinate process to be employed as fluid flow subsystem in the Coriolis flow meter, e.g. a pre-sterilized flexible tubing. FIG. 13 is another example embodiment 4000, where the fluid flow subsystem 4040 of the Coriolis flow meter 4020 is an integral part of a bioprocess unit 4010 itself.

Referring to FIG. 1, the bioprocess unit 4010 is used for growing cell culture in a bio-reactor 4060, and includes a media (block 4050) which typically includes a fluid mixture of nutrients required for cell growth in the bio-reactor 4060. The nutrient fluid is transferred to the bio-reactor 4060 through the fluid flow sub-system 4040, which is a flow conduit, and part of the Coriolis flow meter 4020.

It would be appreciated by those skilled in the art that the bioprocess unit may include several other components, for either upstream and downstream process input to or outputs from the bioreactor 4060. For example, along with media which is primarily a fluid mixture of nutrients, a gas chamber that includes a fluid mixture of gases such as oxygen, nitrogen or carbon di-oxide may also be included that are required for the cell growth in the bioreactor 4060. In this case, another flow conduit would be used to deliver the gases to the bioreactor, and this flow conduit would then be a part of the Coriolis flow meter, similar to the embodiment of FIG. 13. The embodiment of FIG. 13 also covers downstream processes like waste collection, cell chromatography, cell harvesting, cell clarification, cell purification, harvesting, capturing or purification of expressed biomolecules and the like where the flow conduit (and therefore, the fluid flow subsystem) would be between the bio-reactor and a chamber that receives the output from the bio-reactor for any of the downstream processes. The bio-reactor referred herein may be any of a stirred tank, rocking, single-use or multi-use bio-reactor, or any other type, that is used in the field of bioprocessing. Thus, the embodiment of FIG. 13, due to the modular configurations described in referenced to FIG. 2, and other embodiments hereinabove, allows a flow conduit of a bioprocess unit to be shared as the fluid flow subsystem of the Coriolis flowmeter, thus optimizing and simplifying the process of measurement of the properties of the fluid. The bioprocessing system may also be a dedicated system for downstream processing, including e.g. one or more chromatography systems and/or one or more filtration systems, such as one or more crossflow filtration systems.

The different aspects described herein allow for optimal material choice for the mechanical oscillator with regards to the frequencies of the different oscillation modes, in order to achieve a high level of accuracy in the measurements. Furthermore, the design and material selection for the mechanical oscillator ensures that the impact of material choice for the flow conduit, on the oscillation behavior is limited due to the functional separation of the mechanical oscillator sub-system and the fluid flow sub-system in the embodiments described hereinabove. Thus, the oscillation characteristics are dominated by the material and the geometry of the mechanical oscillator, and only marginally influenced by the fluid containment, which improves the measurements for the fluid.

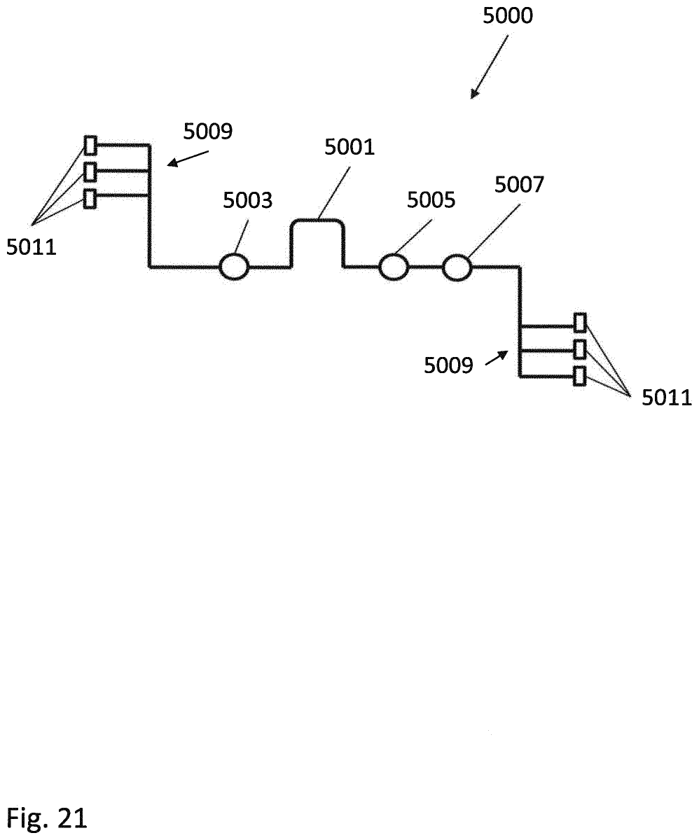

The invention further discloses a single use flow kit 5000 for a bioprocessing system, as illustrated in FIG. 21. This flow kit comprises a fluid flow sub-system 5001, as discussed above, configured to be attached to a mechanical oscillator sub-system, which together form a Coriolis flow meter as discussed above. The flow kit also comprises at least one manifold 5009 fluidically connected to the fluid flow sub-system and at least one single use sensor component 5003,5005,5007 fluidically connected to the fluid flow sub-system. The flow kit may further comprise aseptic connectors 5011 as known in the art, e.g. ReadyMate™ (GE Healthcare) or KleenPak (Pall) for sterile connection to further fluidic systems or units. The kit may be presterilized, e.g. by gamma irradiation, and it may be delivered in a closed package.
The single use sensor component may e.g.comprise a flow cell 5003 with one or more transparent windows for measurement of visible or ultraviolet light absorption, which is useful e.g. for monitoring of protein concentrations. Additionally, or alternatively, the single use sensor component may comprise a single use pressure sensor 5005 as known in the art and available from e.g. PendoTECH. Conductivity (indicative of ionic strength) may be measured with a single use conductivity sensor 5007 as known in the art and available from e.g. SciLog or PendoTECH. The flow kit may further comprise a length of flexible tubing suitable for mounting in a peristaltic pump, and/or a single-use pump head for e.g. a centrifugal or membrane pump.
The flow kit may suitably comprise an instruction for attachment of the fluid flow sub-system to a mechanical oscillator sub-system of a Coriolis flow meter and for connecting the flow kit to a bioprocessing system, e.g. a chromatography or filtration system or a bioreactor. The fluid-contact materials of the flow kit can suitably be of grades compliant with the USP VI (US Pharmacopeia) requirements.

While only certain features of the invention have been illustrated and described herein, many modifications and changes will occur to those skilled in the art. It is, therefore, to be understood that the appended claims are intended to cover all such modifications and changes as fall within the true spirit of the invention.

1-34. (canceled)

35. A Coriolis flow meter for measuring one or more properties of a fluid, the Coriolis flow meter comprising:
a disposable-part sub-system comprising:
a flow conduit configured to provide a flow path for the fluid,
one or more actuators configured for generating oscillations in the fluid through the flow conduit, and
one or more sensors configured for receiving a Coriolis response from the fluid through the flow conduit,
wherein at least one the flow conduit, the one or more actuators, or the one or more sensors is configured as a disposable part; and
an electronics circuitry coupled to the disposable-part sub-system, and configured to trigger the one or more actuators and the one or more sensors, and configured to process the Coriolis response received from the one or more sensors to generate one or more measurements representative of the one or more properties of the fluid.

36. The Coriolis flow meter of claim 35 wherein the flow conduit is the disposable part.

37. The Coriolis flow meter of claim 35 wherein a combination of the one or more actuators and the one or more sensors is the disposable part.

38. The Coriolis flow meter of claim 35 wherein a combination of the flow conduit, the one or more actuators and the one or more sensors is the disposable part.

39. The Coriolis flow meter of claim 35, further comprising a frame to house at least one of a flow conduit, one or more actuators, and one or more sensors.

40. The Coriolis flow meter of claim 39, further comprising one or more snap-in mechanical connectors for snap-in configuration.

41. The Coriolis flow meter of claim 39, further comprising one or more electrical connectors in a mother-daughter pair.

42. (canceled)

43. The Coriolis flow meter of claim 35, wherein the flow conduit is of a U-shape.

44. The Coriolis flow meter of claim 35, wherein the flow conduit is made of polymer.

45. The Coriolis flow meter of claim 35, wherein the flow conduit is made of silicone.

46. The Coriolis flow meter of claim 35, wherein the flow conduit is made of glass.

47. The Coriolis flow meter of claim 35, wherein the flow conduit is made of metal.

48. The Coriolis flow meter of claim 35, wherein the one or more measurements are used for monitoring a bioprocess.

49. The Coriolis flow meter of claim 35, wherein the one or more properties comprise at least one of mass flow rate, density, or temperature of the fluid.

50. A bioprocessing system for monitoring one or more properties of a fluid used in a bioprocess unit, the bioprocessing system comprising:
an inlet tubing and an outlet tubing of the bioprocess unit, wherein the inlet tubing is connected to an inlet process connect, and the outlet tubing is connected to an outlet process connect;
a Coriolis flow meter coupled to the inlet process connect and the outlet process connect, wherein the Coriolis flow meter comprises:
a disposable-part sub-system comprising:
a flow conduit configured to provide a flow path for the fluid,
one or more actuators configured for generating oscillations in the fluid through the flow conduit, and
one or more sensors configured for receiving a Coriolis response from the fluid through the flow conduit,
wherein at least one the flow conduit, the one or more actuators, or the one or more sensors is configured as a disposable part; and
an electronics circuitry coupled to the disposable-part sub-system, and configured to trigger the one or more actuators and the one or more sensors, and configured to process the Coriolis response received from the one or more sensors to generate one or more measurements representative of the one or more properties of the fluid; and
a monitoring unit configured for receiving the measurements representative of the one or more properties of the fluid, and configured to use the measurements to control the bioprocess.

51. The bioprocessing system of claim 50 wherein the flow conduit is the disposable part.

52. The bioprocessing system of claim 50 wherein a combination of the one or more actuators and the one or more sensors is the disposable part.

53. The bioprocessing system of claim 50 wherein a combination of the flow conduit, the one or more actuators and the one or more sensors is the disposable part.

54. The bioprocessing system of claim 50 further comprising a frame to house at least one of a flow conduit, one or more actuators, and one or more sensors.

55. The bioprocessing system of claim 50 wherein the flow conduit is made of at least one of polymer, glass, silicone, metal.

56. The bioprocessing system of claim 50 wherein the one or more properties comprise at least one of mass flow rate, density, or temperature of the fluid.

57. (canceled)

58. A method for measuring one or more properties of a fluid using a Coriolis flow meter, the method comprising:
providing a disposable-part sub-system, and an electronics circuitry coupled to the disposable-part sub-system, wherein the disposable-part sub-system comprises:
a flow conduit configured to provide a flow path for the fluid,
one or more actuators configured for generating oscillations in the fluid through the flow conduit, and
one or more sensors configured for receiving a Coriolis response from the fluid through the flow conduit,
wherein at least one the flow conduit, the one or more actuators, or the one or more sensors is configured as a disposable part;
transmitting an electrical signal to trigger oscillations in the fluid;
receiving a Coriolis response from the fluid; and
processing the Coriolis response to obtain one or more measurements representative of the one or more properties of the fluid.

59. The method of claim 58 further comprising monitoring a bioprocess using the one or more measurements.

60. The method of claim 58 wherein the one or more properties comprise at least one of mass flow rate, density, or temperature of the fluid.

61. A method for monitoring one or more properties of a fluid in a bio-process of a bioprocessing system, the method comprising:
coupling an inlet tubing and an outlet tubing of a bioprocess with a Coriolis flow meter using process connects, wherein the Coriolis flow meter comprises:
a disposable-part sub-system comprising:
a flow conduit configured to provide a flow path for the fluid,
one or more actuators configured for generating oscillations in the fluid through the flow conduit, and
one or more sensors configured for receiving a Coriolis response from the fluid through the flow conduit,
wherein at least one the flow conduit, the one or more actuators, or the one or more sensors is configured as a disposable part; and
an electronics circuitry coupled to the disposable-part sub-system, and configured to trigger the one or more actuators and the one or more sensors, and configured to process the Coriolis response received from the one or more sensors to generate one or more measurements representative of the one or more properties of the fluid;
transmitting an electrical signal to trigger oscillations in the fluid;
receiving a Coriolis response from the fluid;
processing the Coriolis response to obtain one or more measurements representative of the one or more properties of the fluid; and
monitoring the bio-process using the one or more measurements,
wherein the one or more properties comprise at least one of mass flow rate, density, or temperature of the fluid.

62. (canceled)

63. A single use flow kit for a bioprocessing system, comprising:
a fluid flow sub-system configured to be attached to a mechanical oscillator sub-system, forming a Coriolis flow meter upon attachment to said mechanical oscillator sub-system;
at least one manifold fluidically connected to said fluid flow sub-system; and
at least one single use sensor component fluidically connected to said fluid flow sub-system.

64. The single use flow kit of claim 63, further comprising aseptic connectors.

65. (canceled)

66. The single use flow kit of claim 63, wherein said single use sensor component comprises a flow cell with one or more transparent windows for measurement of visible or ultraviolet light absorption.

67. The single use flow kit of claim 63, wherein said single use sensor component comprises a single use pressure sensor.

68. The single use flow kit of claim 63, wherein said single use sensor component comprises a single use conductivity sensor.

69. The single use flow kit of claim 63, further comprising an instruction for attachment of the fluid flow sub-system to a mechanical oscillator sub-system of a Coriolis flow meter and for connecting the flow kit to a bioprocessing system.

70-71. (canceled)
